(19) United States
(12) Patent Application Publication
(10) Pub. No.: US 2014/0062083 A1
(43) Pub. Date: Mar. 6, 2014

(54) Method For Reinforcing A Connection Tube Having An Expansion Part, And Connection Tube Having An Expansion Part Reinforced By Said Method

(71) Applicant: Jin-Uk Shin, Seoul (KR)

(72) Inventor: Jin-Uk Shin, Seoul (KR)

(21) Appl. No.: 14/114,593

(22) PCT Filed: May 23, 2011
(86) PCT No.: PCT/KR2011/003750

§ 371 Date: Oct. 29, 2013

(30) Foreign Application Priority Data
Apr. 29, 2011 (KR) 10-2011-0040751

(51) Int. Cl. F16L 13/14; B29D 23/00

(52) U.S. Cl. CPC F16L 13/14; B29D 23/003
USPC 285/382.7; 156/158

(57) ABSTRACT

The present invention relates to a method for reinforcing a connection tube having an expansion part, and to a connection tube having an expansion part reinforced by said method, characterized in that, in the method, a reinforcing tube manufactured using a homogeneous or heterogeneous synthetic resin, which is mounted on the outer surface of one end of a tube body formed by extruding a synthetic resin, and said tube body, in which the expansion part is to be formed, are heated to the glass transition temperature thereof. Then, the end of the tube body is fitted and fixed into an external former mold for expansion within a range in which said reinforcing tube is mounted, and an expansion member is inserted into the tube body so as to expand and form the end of the tube body on which the reinforcing tube is mounted. The connection tube reinforced as described above is expanded while the reinforcing tube made of the resin material is mounted on the end of the tube body in which the expansion part is to be formed. Thus, the reinforcing tube supplements the expansion part, which is relatively thin, due to the extension thereof, so as to prevent the expansion part from being damaged by external impacts and to prevent a bent portion of the expansion part from being broken by internal or external pressure, such as soil pressure or water pressure.

### TECHNICAL FIELD

The present invention is related to a method for reinforcing connection tubes of a synthetic resin—for example, a one-way pipe, a pumping pipe, an elbow-type pipe or T-type pipe, etc. More specifically, the present invention reinforces the weakness of the expansion part, which comes from its thinness in the process of forming it, in order to prevent it from being broken by external impacts or external forces.

### BACKGROUND

In general, a synthetic resin pipe which is used for a water works pipe, a sewer pipe, or an industrial or agricultural drainpipe is sequentially formed as a cylindrical type. The synthetic resin pipe is cut for convenience of storage and transport, and then the cut pipe is recombined by using various methods.

There are various methods to combine each synthetic resin pipe. For example, one method makes each synthetic resin pipe be contacted with each other, wraps the contacted part of the pipes by using E/F sheets and then implements electrofusion fittings by using external electric currents.

However, the method stated above has several problems in that i) equipment for electrofusion fittings is expansive and voluminous, ii) the leakage ratio is somewhat high because uniformly attaching the E/F sheets to the synthetic resin pipes is difficult, and iii) adhesion performance can be deteriorated by high humidity in the external environment.

The other method to recombine pipes forms a round flange at the ends of the pipes and combines the faced pipes with the round flange by using nuts and bolts.

However, the method using the flange also has a high leakage ratio because the pipes which are made of synthetic resin are expanded and contracted repeatedly by variations in external temperature, and the combined part of the pipes is deformed by stress forces of direction to the axis.

In recent years, a method using connection parts, by which pipes are continuously inserted and combined, and which are equipped at one end of the one-way pipe, has been widely used in the related art. In accordance with this method, one end of the one-way pipe has an outer protruded expansion part. A watertight member, like a rubber packing, is inserted into the expansion part, and provides the connection part of the tubes with watertightness, and prevents deformation of the tubes by the repeated expansion and contraction which results from variations in external temperature.

For instance, Kim (1) (Korean Patent No. 10-562163) discloses a one-way pipe for convenient connection by using an expansion part which is formed at one side of the synthetic resin pipe. Kim (1) with FIG. 1 attached to this document is fully explained as follows.

FIG. 1 is a sectional view illustrating the formation process for an expansion part of a conventional one-way pipe. As illustrated in FIG. 1, a method to make the one-way pipe which has the expansion part 400 is as follows.

Firstly, a synthetic resin tube 100 is formed by extruding synthetic resins. One end of the synthetic resin tube 100 is inserted into a molding frame 600 at which the grooves 610 for expansion tube are formed, and then a molding frame 600 is heated in order to increase the temperature of the synthetic resin 100 to the glass transition temperature. The expansion member 200 is then slowly inserted into the synthetic resin tube 100, and the expansion part 400 is formed in accordance with the form of the expansion member 200 and the grooves 610 for the expansion tube. A refrigerant is then supplied to the molding frame 600 while the expansion part 400 is being formed.

As illustrated in FIG. 2, Kim (2) (Korean Patent No. 10-833815) discloses a one-way pipe which easily connects pipes and has resistance to hydraulic pressure.

FIG. 2 is a sectional view of an other conventional one-way pipe. As illustrated in FIG. 2, if the other tube body 120 is inserted into the expansion part 112 which is formed at one end of the tube body 110, a watertight member 130 for pressurization is installed at the groove 112a for installation which is formed at the expansion part 112. The rims 116, 127 are formed at the end part of the expansion part 112 and the center part of the other tube body 120 respectively. The rims 116, 127 are configured to be combined by the tighten band 150, and thereby Kim (2) facilitates the connection between pipes and has watertightness.

However, conventional one-way pipes can be easily broken because the expansion part is thin and directly impacted by external forces. If water permeates the gap between two pipes which are connected by the expansion part, the expansion part burst by the turgid pressure of the watertight member.

In order to reinforce the expansion part, Kim (3) (Korean Patent No. 10-562163) expands the expansion part of the synthetic resin with heat and bridges the synthetic resin by Gamma ray or electron beam. However, Kim (3) needs additional apparatuses, and the reliability of its effects is poor.

In general, water works pipes and sewer pipes are placed underground. If external or internal impacts are applied to the expansion part, the bending part of the lengthened expansion part cannot easily absorb the impact. Therefore, the unabsorbed oscillating wave impacts the bending part and breaks it.

### TECHNICAL PROBLEM

In order to resolve the problems stated above, the present invention seeks to reinforce the thin expansion part of the connection tube and prevent the expansion part from being broken by external or internal impact.

### Solution To The Problem

The present invention discloses (a) installing a reinforcing tube which is made of a homogeneous or heterogeneous synthetic resin on an outer surface of one end of a tube body which is formed by extruding a synthetic resin; (b) heating a reinforcing tube and a tube body, in which an expansion part is to be formed, to a glass transition temperature; (c) fixing the one end of the tube body by inserting it into an external molding frame within a range in which the reinforcing tube is installed; and (d) expanding and forming the one end of the tube body, at which the reinforcing tube is installed, by inserting an external member into the tube body.

### EFFECT OF THE INVENTION

The present invention i) reinforces the weakness, which comes from its thinness in the process of its formation, of the expansion part, ii) prevents the expansion part from being broken by external impact or external forces (i.e., earth pressure or hydraulic pressure), and iii) if external or internal vibrations are transmitted to the connection tube, vibration impacts which come from the tube body are dispersed and softened by the reinforcing tube, and thereby the reinforcing tube prevents the bending part of the expansion part from being broken.

### BRIEF DESCRIPTION OF THE DRAWINGS

FIG. 1 is a sectional view illustrating the formation process for an expansion part of a conventional one-way pipe.

FIG. 2 is a sectional view of another conventional one-way pipe.

FIG. 3 is a sectional view for explaining a method for reinforcing the one-way pipe, according to the present invention.

FIG. 4 is a sectional view illustrating the one-way pipe to which the reinforcing tube of FIG. 3 is installed.

FIG. 5 is a sectional view illustrating the application of a condition wherein the one-way pipe at which the reinforcing tube of FIG. 4 is installed.

FIGS. 6a and 6b are sectional views of a one-way pipe according to the 1st example of FIG. 4.

FIGS. 7a and 7b are sectional views of a one-way pipe according to the 2nd example of FIG. 4.

FIG. 8 is a sectional view of a one-way pipe according to the 3rd example of FIG. 4.

FIGS. 9a and 9b are sectional views illustrating connection tubes according to examples of a straight pipe and an elbow-type pipe.

FIGS. 10a, 10b and 10c are sectional views illustrating examples of connection tubes with a T type.

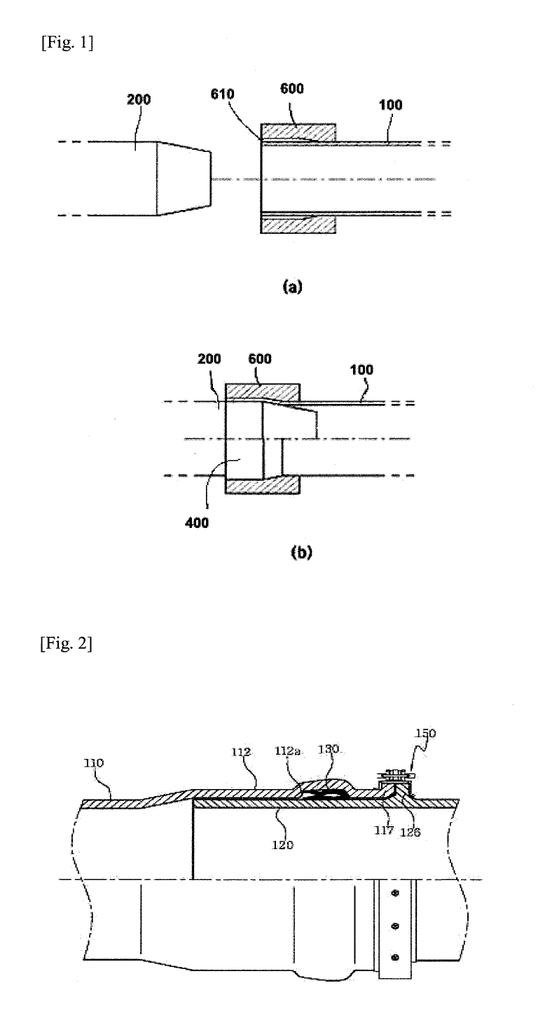

### DETAILED DESCRIPTION

Preferred embodiments of the invention are now described in detail with reference to the accompanying drawings as follows. As described in the present invention, specific descriptions which relate to well-known art or specific details about the elements, if blurring the gist of this invention, are omitted.

The synthetic resin tubes of the present invention can be materials generally used in related industries—for example, PE (polyethylene), PP (polypropylene) or ABS (acrylonitrile butadiene styrene) or more preferably PVC (poly vinyl chloride). However, these examples cannot limit the scope of the present invention.

Firstly, one embodiment wherein the present invention is applied to the one-way pipe will be explained hereinafter.

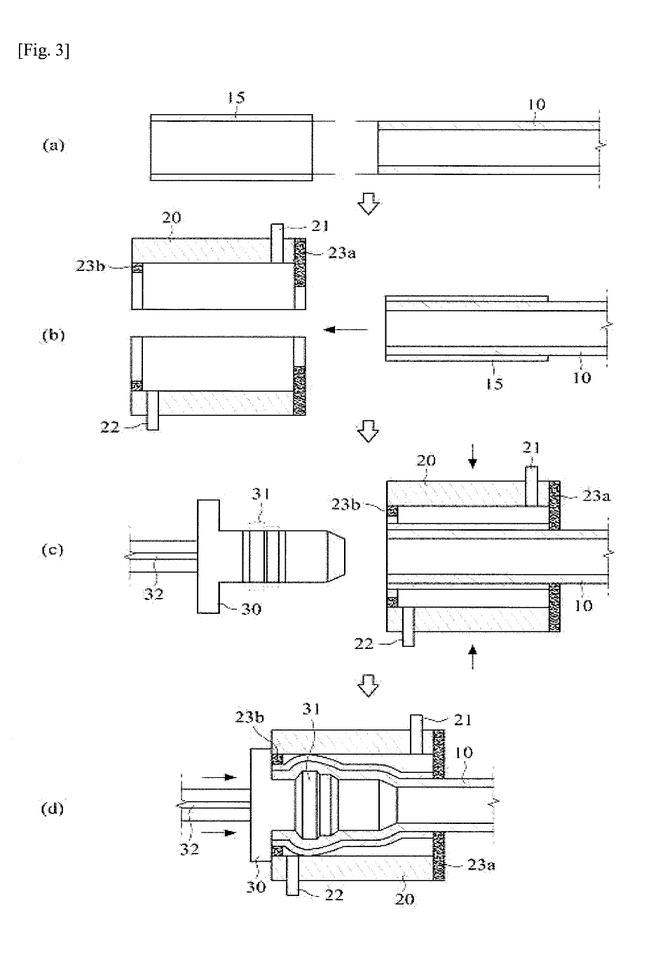

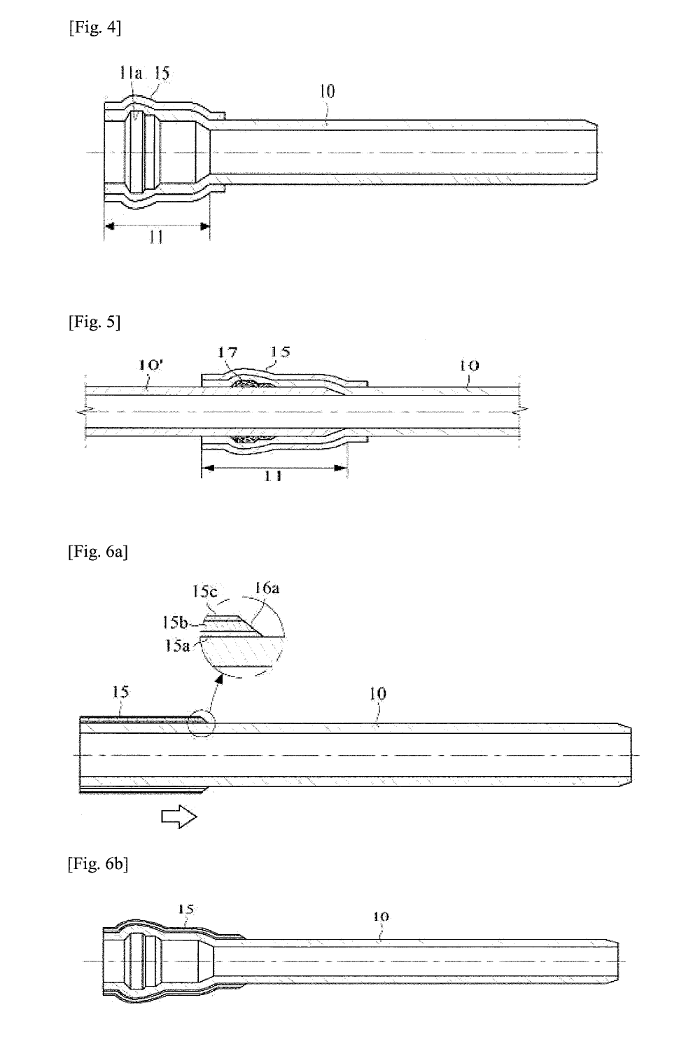

FIG. 3 is a sectional view for explaining the method for reinforcing a one-way pipe, according to the present invention. FIG. 4 is a sectional view illustrating the one-way pipe to which the reinforcing tube of FIG. 3 is installed. FIG. 5 is a sectional view illustrating the application of the one-way pipe at which the reinforcing tube of FIG. 4 is installed.

The tube body 10 is made by extruding synthetic resin. A reinforcing tube 15 is installed by inserting it into one end of the tube body 10, at which the expansion part 11 will be formed. The reinforcing tube 15 is homogeneous or heterogeneous synthetic resin which has different properties from the tube body 10. The inner diameter of the reinforcing tube 15 is equal to or larger than the outer diameter of the tube body 10, to which the reinforcing tube 15 is to be installed, in order to be attached to the outer surface of the tube body 10. The length of the reinforcing tube 15 is sufficient, which is larger than the range at which the expansion part 11 of the tube body 10 is to be formed.

The reinforcing tube 15 is preferably made of softer or harder synthetic resin than the synthetic resin which forms the tube body 10 because it effectively reduces impact fatigues by differentiating abilities for shock absorption when external impacts or external forces which are applied to the reinforcing tube 15 are transferred into the tube body 10.

The reinforcing tube 15 is installed at one end of the tube body 10. The inner space of the one end of the tube body 10, at which the expansion part 11 is to be formed, and the outer space of the reinforcing tube 15 are heated to the glass transition temperature by using an electric heating appliance. One end of the tube body 10, to which the reinforcing tube 15 is installed, is inserted into the external molding frame 20 and fixed.

On the other hand, a publicly known external molding frame for expansion can be applied to the external molding frame for expansion of the present invention. However, the present invention discloses technical features for expanding the tube by using an elastic member 23a, 23b for fixing the tube body 10 on the front side and back sides, respectively, of the external molding frame for expansion. The external molding frame for expansion 20 has an inlet 21 at its one end, in which a refrigerant, like water, can be injected and an outlet at its other end, from which the refrigerant can be discharged. The inner space of the external molding frame for expansion 20 has upper and lower molding frames that have a predetermined space for filling the refrigerant. At this time, the elastic member 23a is relatively longer than the elastic member 23b because the elastic member 23a which is installed at the back side of the external molding frame 20 directly contacts with the tube body 10, and the elastic member 23b which is installed at the front side of the external molding frame 20 fixes the expansion part by an expanding process.

The tube body 10 to which the reinforcing tube 15 is installed is fixed on the external molding frame. The expansion member 30, which has a larger outer diameter than the inner diameter of the tube body 10, is slowly inserted into the tube body 10 in order to expand the tube body 10 and the reinforcing tube 15 simultaneously.

The expansion member 30 is inserted into the tube body 10 on which the reinforcing tube 15 is installed, and then a refrigerant, like water, is supplied through the inlet 21 of the external molding frame 20. The one-way tube having the reinforced expansion part is completed because the pressure of the refrigerant fixes and cools the formed expansion part 11.

Meanwhile, the watertight groove 11a for inserting a watertight member 17, like a rubber packing, can be formed in the expansion part 11 of the tube body 10 by using an expansion member 30 which has a protrusion part 31 which is expanded by oil pressure.

The protrusion part 31 is not expanded when the expansion member 30 is inserted into the tube body 10. The watertight groove 11a can be formed at the expansion part 11 by expanding the protrusion part 31 by supplying it with oil pressure in the process of expansion after insertion in the tube body 10.

The problem wherein the expansion part is relatively thinned is redeemed by expanding the expansion part after installing the reinforcing tube 15 at one end of the tube body 10 at which the expansion part is to be formed. Consequently, the expansion part cannot be easily broken by external shock or external pressure of soil or water.

FIGS. 6a and 6b are sectional views of the one-way pipe according to the 1st example of FIG. 4. In FIG. 6a, one end of the reinforcing tube 15, which faces the tube body 10, is chamfered out so that it has an outer inclined plane, and is installed in tube body 10. In FIG. 6b, the reinforcing tube 15, which has an outer inclined plane, has an inclined plane which is gradually expanded by forming and expanding the tube body 10.

If internal or external vibrations are applied to the expansion part 11, the expansion part 11 can be broken because vibration waves cannot correspond to the variation of the thickness owing to the reinforcing tube 15 and cannot be easily transferred to the expansion part 11. However, if the expansion part 11 is reinforced by the reinforcing tube 15 which has an outer inclined plane, the expanded tube body 10 alleviates the difference of the thickness and gradually disperses the vibration waves from the tube body 10 in accordance with the inclined plane 16a and prevents breakdown.

The reinforcing tube 15 can be a multiple-layer pipe which has different properties as well as a single-layer pipe which has single properties in accordance with choices by a user who would like to use this invention. Furthermore, various multiple-layer pipes which are known in the related art can be applied in order to promote antimicrobial activity, shock absorption ability and strength.

For example, a three-layer impact-resistant water pipe which comprises an inner layer 15a, a central layer 15b and an outer layer 15c is disclosed at Shin (Korean Patent Nos. 10-338254 and 10-797185) and can be applied to the reinforcing tube 15 of the present invention.

If the inner layer 15a and the outer layer 15c of the three-layer reinforcing tube 15 use polyvinyl chloride which has the same properties and the central layer 15b uses softer or harder polyvinyl chloride than those of the inner layer 15a and the outer layer 15c, the present invention effectively absorbs external shock or impact and prevents the expansion part from being broken as well as having tensile strength and impact strength because a reflected wave is offset by a succeeding wave (i.e., principle of superposition).

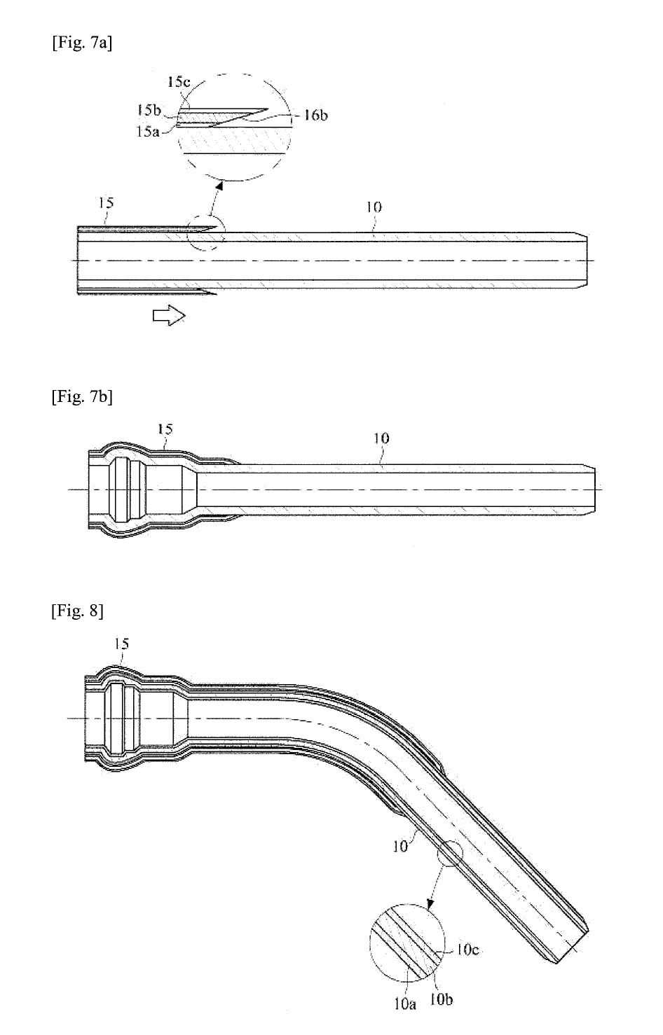

FIGS. 7a and 7b are sectional views of the one-way pipe according to the 2nd example of FIG. 4. In FIG. 7a, one end of the reinforcing tube 15, which faces the tube body 10, is chamfered out so that it has an inner inclined plane and is installed in tube body 10. In FIG. 7b, the reinforcing tube 15, which has an inner inclined plane, has an inclined plane which is gradually expanded by forming and expanding the tube body 10.

As the reinforcing tube 15 has an outer inclined plane 16a of FIG. 6b, if the reinforcing tube 15 has the inner inclined plane 16b, the expanded tube body 10 also alleviates the difference of the thickness and gradually disperses the vibration waves from the tube body 10 in accordance with the inclined plane 16a and prevents breakdown. In addition to this, the one end of the reinforcing tube 15 can be installed at the tube body 10 with a more gentle slope. Furthermore, the present invention has good adhesion properties because each layer having different properties directly contacts with the tube body 10.

FIG. 8 is a sectional view of the one-way pipe according to the 3rd example of FIG. 4. As illustrated in FIG. 8, the reinforcing tube 15 is applied to the tube body 10 of an elbow-type pipe with a predetermined angle as one embodiment of the present invention.

As illustrated in FIG. 8, the reinforcing tube 15 is installed with sufficient length in order to cover the outer surface of the tube body 10 from the one end, at which the expansion part is formed, to the bent position with a predetermined angle. If the tube body 10 is bent, it is lengthened and thinned. However, the reinforcing tube 15 is installed at the bent part, and thereby it has the ability to absorb shock fatigue and improve strength in accordance with the principles explained above.

In the above cases, a single-layer pipe which has the same properties or a multiple-layer pipe which has different properties can also be applied to the tube body 10. Especially, if the three-layer impact-resistant water pipe of Shin, which has the outer layer 10a, the central layer 10b and the inner layer 10c, is applied to the tube body 10, the present invention will have more desirable effects.

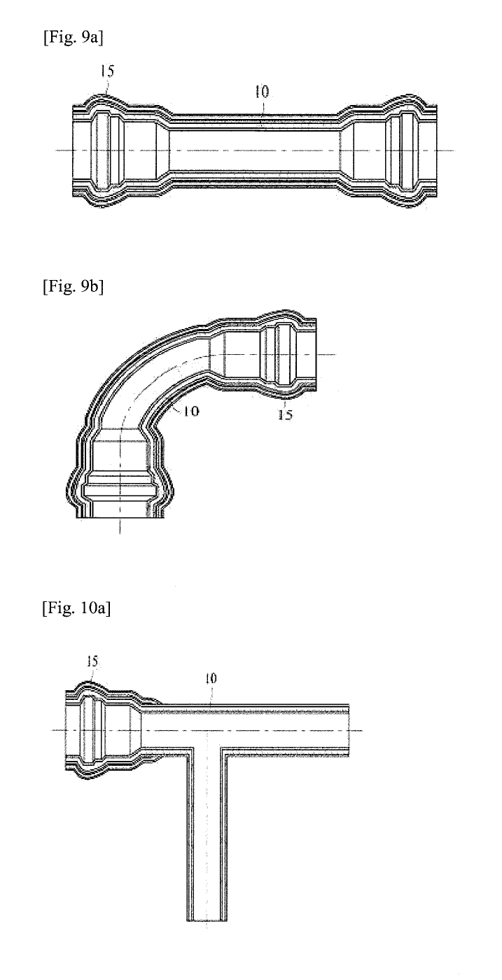

FIGS. 9a and 9b are sectional views illustrating connection tubes according to examples of a straight pipe and an elbow-type pipe. As illustrated in FIG. 9, the expansion part 11 is formed at each end of the tube body 10 which is a straight type or an elbow type, and the reinforcing tube 15 is installed at the expansion part 11 in accordance with the method of the present invention.

As explained above, if the expansion part 11 is formed at each end of the tube body 10, a pipe at which the expansion part is not formed is connected to the expansion part 11.

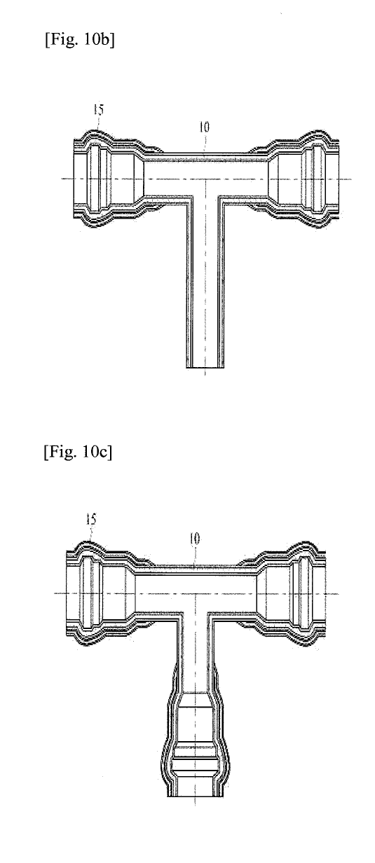

FIGS. 10a, 10b and 10c are sectional views illustrating examples of connection tubes with a T-type pipe. As illustrated in FIG. 10, the tube body 10 is a T-type tube body which has three opening parts. The expansion part 11 is selectively formed at the three opening parts, respectively. The reinforcing tube 15 is installed at the expansion part 11 in accordance with the method of the present invention.

As explained above, the expansion part 11 on which the reinforcing tube 15 is installed is selectively formed at the ends of the T-type tube body 10, a pipe at which the expansion part is not formed is connected to the expansion part 11.

The embodiments described above do not limit the scope of the present invention. Various modifications, changes and additions could be applied to the present invention by a skilled artisan.

1. A method for reinforcing a connection tube, comprising:
(a) installing a reinforcing tube which is made of a homogeneous or heterogeneous synthetic resin on an outer surface of one end of a tube body which is formed by extruding a synthetic resin;
(b) heating a reinforcing tube and a tube body, in which an expansion part is to be formed, to a glass transition temperature;
(c) fixing the one end of the tube body by inserting it into an external molding frame within a range in which the reinforcing tube is installed; and
(d) expanding and forming the one end of the tube body, at which the reinforcing tube is installed, by inserting an external member into the tube body.

2. The method according to claim 1, wherein the reinforcing tube is made of a softer or harder synthetic resin than a synthetic resin which forms the tube body.

3. The method according to claim 2, wherein the reinforcing tube is expanded and formed with an outer chamfer at its one end.

4. The method according to claim 2, wherein the reinforcing tube is expanded and formed with an inner chamfer at its one end.

5. The method according to claim 3, wherein the tube and the reinforcing tube have a plurality of layers which are made of different components respectively.

6. The method according to claim 5, wherein the tube and the reinforcing tube are a triple-layer tube, in which an outer layer and an inner layer have polyvinyl chloride which has the same properties, in which a central layer has softer or harder polyvinyl chloride than the outer layer and the inner layer.

7. The connection tube having a reinforced expansion part, in which the reinforcing tube is installed at the expansion part of the one end of the tube body by the reinforcing method according to claim 1.

8. The connection tube having a reinforced expansion part according to claim 7, wherein the reinforcing tube is a softer or harder synthetic resin than the tube body of the reinforcing tube.

9. The connection tube having a reinforced expansion part according to claim 7, wherein the reinforcing tube has an inclined plane with thickness which is gradually enlarged from the tube body.

10. The connection tube having a reinforced expansion part according to claim 9, wherein the expansion part of the tube body has a watertight groove for inserting a watertight member like a rubber packing.

11. The connection tube having a reinforced expansion part according to claim 9, wherein the tube and the reinforcing tube have a plurality of layers which are made of different components respectively.

12. The connection tube having a reinforced expansion part according to claim 11, wherein the tube and reinforcing tube are a triple-layer tube, in which an outer layer and an inner layer have a polyvinyl chloride which has same properties, in which the central layer has softer or harder polyvinyl chloride than the outer layer and the inner layer.

13. The connection tube having a reinforced expansion part according to claim 12, wherein the connection tube is formed as an elbow type or a T-type, and the expansion part at which the reinforcing tube is installed is selectively formed at one end of the connection tube.
